(19) United States
(12) Patent Application Publication
(10) Pub. No.: US 2002/0174197 A1
(43) Pub. Date: Nov. 21, 2002

(54) Method and system for accurately determining a device location in an arbitrated loop

(75) Inventors: Timothy Jerry Schimke, Oronoco, MN (US); Rick Alan Weckwerth, Rochester, MN (US); Joseph Thomas Writz, Rochester, MN (US)

Correspondence Address: Andrew J. Dillon, BRACEWELL & PATTERSON, L.L.P., Lakewood on the Park, Suite 350, 7600B North Capital of Texas Highway, Austin, TX, 78731, US

(73) Assignee: International Business Machines Corporation

(21) Appl. No.: 09/819,122

(22) Filed: Mar. 27, 2001

(51) Int. Cl. G06F 15/173; G06F 15/177

(52) U.S. Cl. 709/220; 709/223

(57) ABSTRACT

A method for accurately determining a device location in an arbitrated loop having a number of devices and at least one initiator, where each of the devices has a port bypass circuit associated with it. The method includes enabling the port bypass circuits and initializing the arbitrated loop to determine the initiator's enhanced logical address. Next, a port bypass circuit associated with a selected device is disabled and a unique identifier that, in an advantageous embodiment, is a world wide unique address (WWID) of the device and a physical slot location of the selected device is determined. The unique identifier and the physical slot location of the selected device is saved, preferably in a first Table and the port bypass circuit associated with the selected device is enabled. A unique identifier and physical slot location is determined in the above described manner for each of the devices located on the arbitrated loop. Following the determination of the unique identifiers and physical slot locations of all the devices on the loop, the port bypass circuits are disabled and a loop initialization of the arbitrated loop is initiated to determine a unique identifier for each of the plurality of devices. Next, the unique identifiers determined in the loop initialization is mapped with the unique identifiers associated with physical slot locations saved in the first Table to accurately identify the physical slot location of each of the devices.

### BACKGROUND OF THE INVENTION

1. Technical Field

The present invention relates in general to input/output channel and networking systems and, in particular, to an networked system utilizing an arbitrated loop interconnection topology. More particularly, the present invention relates to a method and system for accurately determining a device location in an arbitrated loop.

2. Description of the Related Art

Computer processors and peripheral devices communicate via internal bus systems or channels, through local interfacing such as the Small Computer System Interface (SCSI), and over longer distances through networks. One standard interconnection system is Fibre Channel. Fibre Channel supports three different topologies: point-to-point, Arbitrated Loop and fabric attached. The point-to-point topology attaches two devices directly. The Arbitrated Loop topology attaches devices in a loop. The fabric, also referred to as a switch or router, attached topology attaches a device directly to an active intelligent interconnection scheme that switches Fibre Channel frames between devices. The Arbitrated Loop topology was initially designed to provide a lower cost interconnect than fabrics and to provide more interconnect than point-to-point topologies. The Arbitrated Loop topology was created by separating the transmit and receive fibers associated with each loop port and connecting the transmit output of one loop port to the receive input of the next loop port. Typically, characteristics of the Arbitrated Loop topology include: first, it allows up to 126 participating node ports and one participating fabric port to communicate, second, each node port implements a route filtering algorithm, and third, all ports on a single loop have the same upper 16 bits of the 24-bit Port address identifier.

There are two classifications of devices on an Arbitrated Loop: private loop devices and public loop devices. Public loop devices attempt a Fabric Login (FLOGI) upon initialization. Public loop devices also are cognizant of all twenty four bits of the 24-bit Port native port address identifier. Public loop devices will open the fabric port at Arbitrated Loop Physical Address (ALPA, bits 7 to 0) zero when the domain and area (bits 23 to 8) do not match their domain and area. Private loop devices use only the lower eight bits of the ALPA and can only communicate within the local loop.

Fibre Channel address assignments are automatically determined. At any time, nodes can be added or deleted. When nodes are connected, devices automatically log in and exchange operating parameters with an electronic matrix device, also called a switch, or with other nodes if there is no switch. Fibre Channel Arbitrated Loops support both hard and soft addressing. If there is an address conflict among hard addresses, a conflicting device will either fail to join the loop, and as a result will be inoperable, or the conflicting device will revert to soft addressing and choose some other address.

In general, interconnection of devices in a computer system requires every connected device to have some sort of unique electronic address or identification. In some interconnection systems, device identification is determined by switches or cables, and cannot be electronically changed (referred to as hard addressing in Fibre Channel). For example, for personal computers, identification of a disk drive may be determined by setting switches on the drive, or identification may be determined by which connector is used to attach the drive. In other interconnection systems, devices may automatically be electronically configured each time system power is applied, or each time the system is reset (referred to as soft addressing in Fibre Channel). For automatic configuration, if a device is added or deleted, the assigned identification may change. For example, for Intel compatible personal computers, one industry specification for automatically configuring input/output (I/O) circuit boards is called the Plug and Play ISA Standards. For ISA Plug and Play, each compatible board has a unique identifier that includes a vendor identifier and a serial number. During system initialization, the host computer goes through a process of elimination, based on the unique board identifiers, to isolate each board, and the host computer then assigns a logical device number to each board.

Hard addressing is useful for simplifying interaction between operating systems and peripheral devices. For example, existing operating system software designed for SCSI systems may have a specific built-in address for a boot device. Alternatively, consider a computer that initially boots from software on a removable compact disk (CD). After booting, it may be desirable for the computer to search for a hard disk, and assign the loop address of the hard disk to be the permanent boot device. If the hard disk has hard addressing, then the loop address of the boot device can remain constant for the computer. However, conflicting hard addresses must typically be resolved by human intervention. That is, a human must find the conflicting devices and physically change at least one address. For personal computers, and for SCSI systems with a maximum of 16 devices, finding conflicting addresses is practical. For Fibre Channel, with nodes scattered over, e.g., a campus, finding conflicting hard addresses is impractical.

It is necessary to accurately determine the exact location of peripheral devices on the loop for serviceability reasons. The failing device must be identifiable so that it may be replaced upon failure, which implies a need to specify the location down to, for example, a single slot within a system unit or expansion tower. The location of the device is ordinarily determined by mapping the logical address the device communicates with on the loop to the physical location of the device. The device chooses a logical address based upon a value to the physical location of the device. The device chooses a logical address based upon a value presented to it by the backplane connector (each peripheral device location has a unique value). A problem occurs if there is a fault in the peripheral device or backplane, e.g., a bad pin or broken wire, such that the logical address the device uses does not map correctly to the actual physical location. The devices may still be functioning normally even in the presence of faults. A single fault may result in all the devices being tagged with incorrect physical locations, thus complicating maintenance of a failing resource or device and may ultimately require a more disruptive recovery action to occur.

Accordingly, what is needed in the art is an improved method for identifying devices on an arbitrated loop that mitigates the limitations discussed above.

### SUMMARY OF THE INVENTION

It is therefore an object of the invention to provide an improved arbitrated loop network system.

It is another object of the invention to provide a method for accurately determining a device location in an arbitrated loop.

To achieve the foregoing objects, and in accordance with the invention as embodied and broadly described herein, a method for accurately determining a device location in an arbitrated loop having a number of devices and at least one initiator, where each of the devices has a port bypass circuit associated with it is disclosed. The method includes enabling the port bypass circuits and initializing the arbitrated loop, a Fibre Channel arbitrated loop (FC-AL) in an advantageous embodiment, to determine the initiator's enhanced logical address. Next, a port bypass circuit associated with a selected device is disabled and a unique identifier that, in an advantageous embodiment, is a world wide unique address (WWID) of the device and a physical slot location of the selected device is determined. The unique identifier and the physical slot location of the selected device is saved, preferably in a first Table and the port bypass circuit associated with the selected device is enabled. A unique identifier and physical slot location is determined in the above described manner for each of the devices located on the arbitrated loop. Following the determination of the unique identifiers and physical slot locations of all the devices on the loop, the port bypass circuits are disabled and a loop initialization of the arbitrated loop is initiated to determine a unique identifier for each of the plurality of devices. Next, the unique identifiers determined in the loop initialization is mapped with the unique identifiers associated with physical slot locations saved in the first Table to accurately identify the physical slot location of each of the devices.

In a related embodiment of the present invention, the method further includes determining a set of valid physical addresses for the devices. Following which, a preferred enhanced logical address is assigned to the initiator that does not correspond to an address in the set of valid physical addresses.

The present invention discloses a novel method and mechanism for detecting an incorrect mapping caused by a failure in the backplane or peripheral device(s) when FC-AL devices in a private loop are used in conjunction with port bypass circuits. The present invention also determines what the actual correct mapping is in the presence of the failure(s), to help identify the faulting piece of hardware so that it may be replaced. The present invention utilizes the port bypass circuits in conjunction with information obtained when talking to peripheral devices on the loop to detect cases where the mapping from logical address to physical address is incorrect. The present invention then determines the correct mapping that, in turn, identifies the faulty pieces of hardware for replacement.

The foregoing description has outlined, rather broadly, preferred and alternative features of the present invention so that those skilled in the art may better understand the detailed description of the invention that follows. Additional features of the invention will be described hereinafter that form the subject matter of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates an network system utilizing an arbitrated loop topology that provides a suitable environment for the practice of the present invention; and

FIG. 2 illustrates a high-level process flow for accurately determining a device location in an arbitrated loop according to the principles disclosed by the present invention.

### DETAILED DESCRIPTION OF THE PREFERRED EMBODIMENT

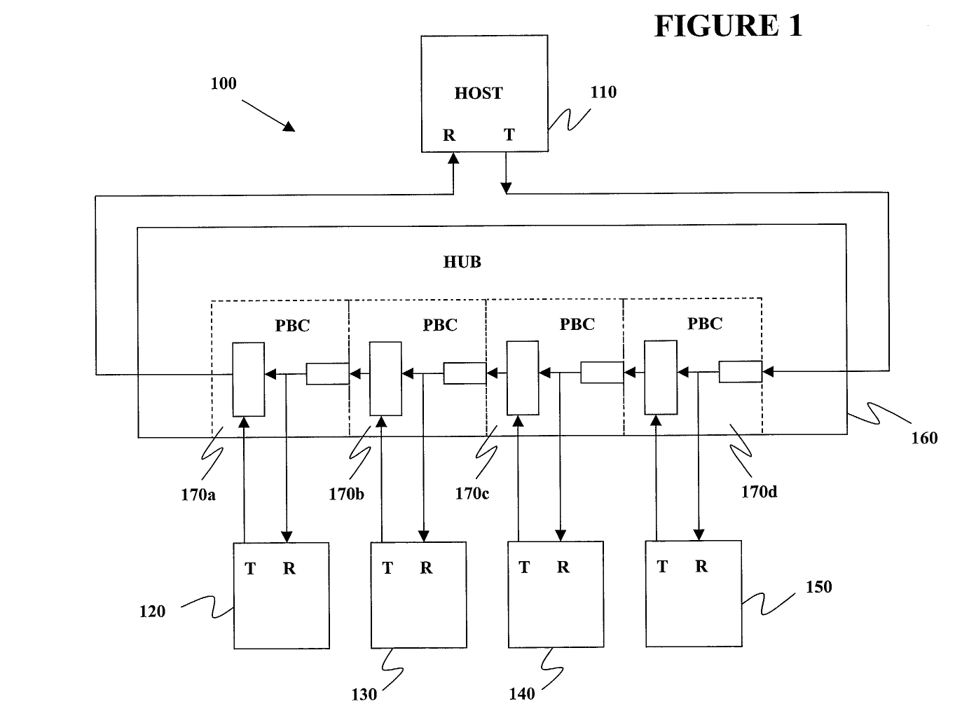

With reference now to the figures and in particular with reference to FIG. 1, there is depicted an exemplary network system 100 utilizing an arbitrated loop topology that provides a suitable environment for the practice of the present invention. Network system 100 includes a host system 110, such as a personal computer (PC), coupled to a first, second, third and fourth devices 120, 130, 140, 150 via a hub 160 utilizing a Fibre Channel Arbitrated Loop (FC-AL) interconnection. It should, however, be noted that the practice of the present invention is not contemplated to be limited to any one particular arbitrated loop topology. Devices 120-130 are typically peripheral devices such as storage devices with Fibre Channel (FC) interfaces and are coupled to the FC-AL on a backplane provided by hub 160. Hub 160 is utilized to connect devices in a loop and is typically a passive device, that is a loop exists within hub 160 and is utilized to maintain the loop's integrity when devices are removed, powered off or fail employing first, second, third and fourth port bypass circuits (PBCs) 170a, 170b, 170c, 170c that are associated with first, second, third and fourth devices 120, 130, 140, 150, respectively. Activation of a PBC will bypass the corresponding device, i.e., removing the device from the loop. Although a Fibre Channel hub 160 is depicted in FIG. 1, it should be readily apparent to those skilled in the art that other switching and/or connection devices may also be advantageously utilized to provide the Fibre Channel hub's function.

Generally, devices connected on an arbitrated loop are logically connected in series and data frames are passed sequentially from one device to the next. At the loop initialization process, e.g., after power-on or a system reset, at least one device generates a loop initialization select master (LISM) frame. It should be noted that multiple devices may simultaneously generate LISM frames. Each device generating a LISM frame includes its unique Fibre Channel world-wide identification number (WWID) as part of the frame while each device receiving a LISM frame compares the identification number in the received frame to its own identification number. In the event that the receiving device has an identification number that is lower than the identification number in the LISM frame, the receiving device substitutes its own identification number in the frame and sends the modified LISM frame to the next device. On the other hand, if the receiving device has an identification number that is higher than the identification number in the LISM frame, the device sends the unmodified LISM frame to the next device. Eventually, all of the LISM frames will contain the lowest identification number of the devices connected to the loop. Accordingly, the device having the lowest identification number becomes the loop master. Next, the loop master device generates a loop initialization fabric address (LIFA) frame that is utilized to allow a device to reclaim an address previously assigned by a fabric.

The loop master device then initiates an arbitration sequence during which each device on the loop chooses one of 127 loop addresses. To accomplish this, the loop master device generates a series of frames, each of which includes a 127-bit number where each bit corresponding to one loop address. It should be noted that there are two possible scenarios. Firstly, the loop may be in the process of being initialized for the first time following power-on or after a system reset. Alternatively, the loop may already be initialized and one or more new devices are being added to the loop. Generally, when a new device is added to an existing loop, all of the devices already configured keep their previously chosen loop addresses. Accordingly, the master device first generates a loop initialization previous address (LIPA) frame and each already configured device sets one bit in the 127-bit address number that corresponds to its previously chosen loop address. Next, the master device generates a loop initialization hard address (LIHA) frame and if a new device is being added to a running loop, the 127-bit address number in the LIHA frame will have bits set previously when a LIPA frame was circulated. In the event that the loop is being initialized for the first time, the LIHA frame will initially have no bits set. When a device having a hard address receives the LIHA frame, the device will set the bit in the 127-bit address number corresponding to its hard address. If the corresponding bit is already set, the device must either cease arbitrating or switch to soft addressing. To complete the loop initialization process, the loop master device generates a loop initialization soft address (LISA) frame. When a device receives the LISA frame and if an address was not selected for the device during a LIPA frame or a LIHA frame, the device may selects any available loop address that has not been assigned by setting the appropriate bit in the 127-bit address number in the frame. Following which, the device passes the frame to the next device in the loop. At the end of this process, all the devices on the loop will have a distinct loop address.

The normal case for devices within an enclosure is for each device, or node, on the loop to have a unique SEL_ID value, which will lead to each node receiving its “preferred enhanced logical address (ALPA).” The SEL_ID is typically a 7-bit value that may be algorithmically converted to an 8-bit preferred ALPA and the devices on the loop receive a SEL_ID through a backplane connector that couples the device to a node on the loop. This ALPA, in conjunction with knowledge of the physical packaging, may then be utilized by an initiator or host driver software to determine the physical location of each device by using the mapping from SEL_ID to ALPA. If there is a fault (bad pin, broken wire, etc.) in either the node or the backplane, the SEL_ID used by the node may not be what was intended. This may result in the ALPA actually used on the loop for the faulty node to no longer be the “preferred ALPA.” Other non-faulty nodes on the loop may also not receive their preferred ALPA because multiple nodes may now be attempting to obtain the same ALPA. In general, a single fault can cause none, some, or all nodes not to receive their preferred ALPA depending on the configuration, the SEL_ID values, and the error encountered.

Because the mapping from ALPA to physical location identifies the correct location only if the nodes receive their preferred ALPA, the system will use incorrect data if some faults are present in the system. Note that the peripheral devices may still be functioning normally even in the presence of faults, so that there is no indication of problems until sometime later when maintenance is attempted. A single fault may result in all nodes being tagged with incorrect physical locations. This will complicate maintenance of a failing resource, and may require a more disruptive recovery action to occur. Systems built upon small computer systems interface (SCSI) devices have a similar concern. However, the SCSI case is typically less severe because in the SCSI case there is no dynamic reassignment of logical addresses so failure typically only affect the faulting device or the faulting device plus the device whose address it now conflicts with.

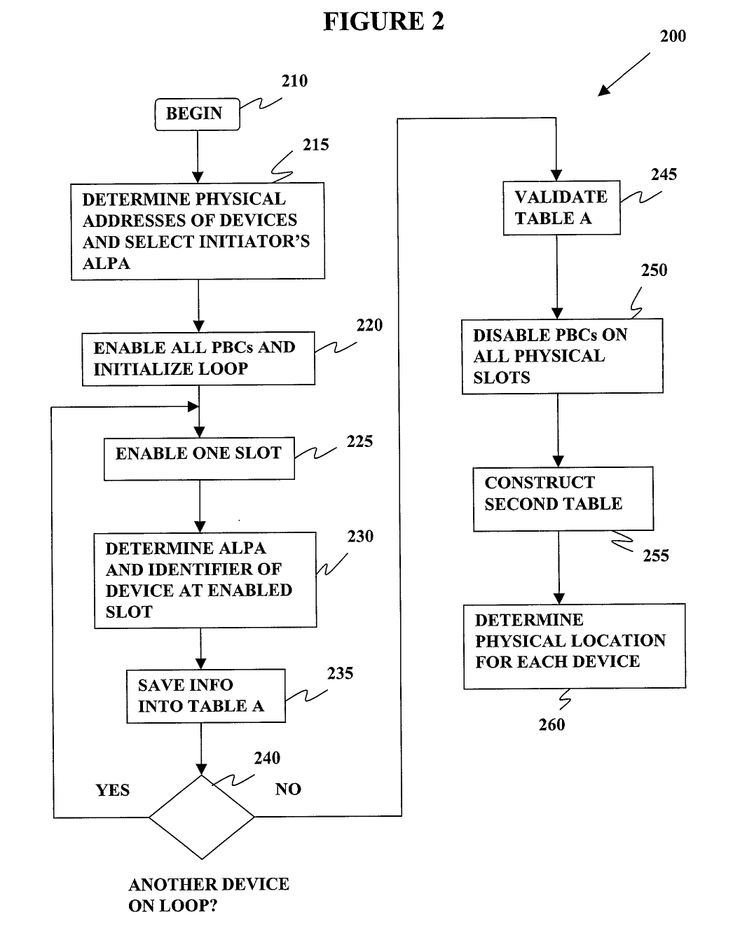

The present invention discloses a novel mechanism for detecting an incorrect mapping caused by a failure in the backplane or device(s) when FC-AL devices in a private loop are utilized in conjunction with port bypass circuits. The present invention also determines what the actual correct mapping is in the presence of failure(s) so that the faulting piece of hardware can be identified and replaced. An exemplary method for accurately determining a device location in an arbitrated loop in accordance with the present invention will hereinafter be described in greater detail in conjunction with FIG. 2, with continuing reference to FIG. 1.

Referring now to FIG. 2, there is illustrated a high-level process flow 200 for accurately determining a device location in an arbitrated loop according to the principles disclosed by the present invention. Process 200 is initiated, as depicted in step 210, when the loop initialization process commences, e.g., at powered on, system reset or at other times as needed such as after a concurrent maintenance action. It is assumed, for ease of explanation, that there are no failing devices with their associated PBCs already enabled.

Next, as illustrated in step 215, an out-of-band communication is accomplished with first, second, third and fourth PBCs 170a-170d to determine the set of valid physical addresses for first, second, third and fourth devices 120, 130, 140, 150, i.e. the set of values that will be provided to the devices via the backplane connector. Host 110, also known as the initiator, will use a preferred ALPA that does not map to any of these physical addresses. Although process 200 will hereinafter be described in the context of a single initiator, the present invention does not contemplate limiting its practice to an arbitrated loop having a single initiator. The principles disclosed by the present invention may also be advantageously utilized in systems having multiple initiator, or host systems, provided that there is an implicit or explicit method of communication to synchronize execution of process 200. It should be noted that a multiple initiator system would ordinarily implement such a method to coordinate access to the PBCs when, e.g., performing loop recovery. After host 110 obtains its preferred ALPA, first, second, third and fourth 170a-170c PBCs are enabled such that only the initiator, i.e., host 110, is present on the loop as depicted in step 220. The loop is then brought up and the set of ALPAs examined. It should be noted that only host's 110 ALPA is present since all of the other devices on the loop have been bypassed. This will establish the ALPA of host 110 and process 200 can proceed to validate that host's 110 ALPA does not map to any of the valid physical addresses obtained above.

Next, the logical address utilized by first, second, third and fourth devices 120, 130, 140, 150 are determined. Beginning in step 225, all the PBCs are enabled except for host 110 and first device 120 to determine the ALPAs used and the WWID of first device 120. It should be noted that the dynamic nature of an ALPA generated from a SEL_ID is not a concern at this time because the number of entries on the loop has been constrained to only host 110 and a single peripheral device so that there will not be any ALPA collisions. Next, as depicted in step 230, the ALPA and WWID of first device 120 is determined and the information is saved in a first Table A. After the information is saved in Table A, as illustrated in decisional step 240, process 200 determines if there is another device on the loop whose ALPA and WWID have not been obtained. Therefore, steps 220 through 240 are repeated for second, third and fourth devices 130, 140, 150. After the ALPAs and WWIDs have been obtained for all the devices on the loop, Table A will contain a listing of all the physical slots indexed by physical locations containing the ALPA and WWID for each physical slot. An illustrative Table A is depicted below. In the illustrated embodiment, host 110 (initiator) is cognizant of the number of devices present on the loop. In other embodiments, the initiator is unaware, at the beginning of process 200, of the number of devices that are present on the loop, thus steps 225-240 will be repeated for every potential device on the loop, irregardless of whether there is an actual device at that physical location.

TABLE A

| PHYSICAL | | |
|---|---|---|
| LOCATION | ALPA | WWID |
| “host” | xx | xxx |
| “first device” | xx | xxx |
| “second device” | xx | xxx |
| “third device” | xx | xxx |
| “fourth device” | xx | xxx |

Next, as depicted in step 245, each entry in Table A is validated. It should be noted that the fault isolation procedure is different at initial power-on time than at later times because later loop initializations may have devices using the “last-known ALPA” value. In the case of initial power-on time, the actual ALPA for each entry in table A was determined utilizing what the device believed its SEL_ID value was. This is because the first time the device entered the loop after initial power-on, it was the only device active on the loop besides the initiator. Thus, any entry in which the ALPA generated from the physical address (i.e. SEL_ID) is not the same as the actual ALPA indicates a fault in either the backplane or the device. These faults are then reported to host 110 to initiate corrective actions.

The fault isolation procedure for situations other than at initial power-on requires that a history of the last execution of this sequence of steps be kept to properly identify the faulting device(s). An entry in Table A for a device that existed at a prior time, i.e. same WWID, is skipped because the device used the “previously-assigned ALPA” value and any needed fault reporting would have occurred on early execution of this sequence. Each entry that did not exist at a prior time, i.e. no matching WWID in the last Table A, is checked. These devices most likely entered the loop dynamically, i.e. concurrently added, when other devices were already on the loop. In this case the device attempted to use its SEL_ID value to obtain an ALPA, but would not have been successful if another device already had it. Because of this, a fault is reported only if the ALPA, generated from the physical address, i.e. SEL_ID, is different than the actual ALPA, and there is no other entry in table A which does have the ALPA mapped from the physical address for this device. It should be noted that it is possible (but highly unlikely) for a fault to go undetected if a device is added in the presence of other faults previously reported. This fault would have had to be present in the device slot or device being added and would be identified the next time the system goes through an initial power-up sequence.

After validating the entries in Table A, first, second, third and fourth PBCs are disabled as illustrated in step 250. Alternatively, in other advantageous embodiments, the device slots with faults present and identified can be bypassed until maintenance is completed. This may simplify error recovery procedures in the host system. A second Table B consisting of ALPAs and WWIDs for each ALPA is constructed based upon the loop configuration with all the devices present, i.e., all PBCs disabled.

The physical location for first, second, third and fourth devices' 120, 130, 140, 150 entries in Table B is next determined utilizing the information in Table A, as depicted in step 260. For each entry in Table B, the physical location of the device is obtained from the entry in Table A containing the matching WWID. An illustrated Table B is depicted below.

TABLE B

| | | PHYSICAL |
|---|---|---|
| ALPA | WWID | LOCATION |
| xx | xxx | “host” |
| xx | xxx | “first device” |
| xx | xxx | “second device” |
| xx | xxx | “third device” |
| xx | xxx | ”fourth device” |

It should be noted that the ALPA is not utilized because a given device's ALPA may have been remapped to a different value if there were multiple devices attempting to obtain the same ALPA. This might occur if multiple devices thought they had the same SEL_ID because of a hardware fault. It should be noted that if all the physical slots with identified faults were bypassed in step 250, then the physical location retrieved out of Table A will be the same as the physical location generated algorithmically from the ALPA.

If there are PBC(s) already enabled for failing device(s) on the loop, the exact same steps described above may be utilized except that any physical slot being bypassed because of a device fault remains bypassed for all the steps. The initial power-on sequence of steps discussed above may also be utilized at later times if there is a method to force the nodes not to use the “previously-assigned ALPA” value when obtaining the ALPA during loop initialization. Examples of such a method might be forcing the nodes back through a power-on sequence, a vendor-unique method to make the node “forget” that it has already had obtained an ALPA previously, a mode-pin disabling all use of the “previously-assigned ALPA,” or some other mechanism.

In an advantageous embodiment, the method for accurately determining a device location in an arbitrated loop disclosed by the present invention is implemented as a computer executable software program utilized by host 110. As depicted in FIG. 1, the present invention may be implemented within an exemplary data processing system, e.g., host 110 that may be embodied as a computer workstation platform, such as IBM's RS/6000. It should be noted that although the present invention has been described, in one embodiment, in the context of a computer workstation, those skilled in the art will readily appreciate that the present invention described herein-above may be implemented, for example, by other suitable electronic module to execute a corresponding sequence of machine-readable instructions. These instructions may reside in various types of signal-bearing media. In this respect, one aspect of the present invention concerns a programmed product, that includes signal-bearing media tangibly embodying a program of machine-readable instructions executable by a digital data processor to perform the process for accurately determining a device location in an arbitrated loop described above. The present invention does not contemplate limiting its practice to any particular type of signal-bearing media, i.e., computer readable medium, utilized to actually carry out the distribution. Examples of signal-bearing media includes recordable type media, such as floppy disks and hard disk drives, and transmission type media such as digital and analog communication links and wireless.

While the invention has been particularly shown and described with reference to a preferred embodiment, it will be understood by those skilled in the art that various changes in form and detail may be made therein without departing from the spirit and scope of the invention.

What is claimed is:

1. A method for accurately determining a device location in an arbitrated loop having a plurality of devices and at least one initiator, wherein each of said plurality of devices having a port bypass circuit, comprising:
(a) enabling said port bypass circuits and initializing said arbitrated loop to determine said initiator's enhanced logical address;
(b) disabling a port bypass circuit associated with a selected device and determining a unique identifier and a physical slot location of said selected device;
(c) saving said unique identifier and said physical slot location of said selected device and enabling said port bypass circuit associated with said selected device;
(d) repeating (b) through (c) for each of said plurality of devices;
(e) disabling said port bypass circuits and performing a loop initialization of said arbitrated loop to determine a unique identifier for each of said plurality of devices; and
(f) mapping said unique identifiers determined in (e) with said unique identifiers associated with physical slot locations in (c) wherein said physical slot location of each of said plurality of devices is accurately determined.

2. The method as recited in claim 1, further comprising determining a set of valid physical addresses for said plurality of devices.

3. The method as recited in claim 2, further including assigning a preferred enhanced logical address to said initiator that does not correspond to an address in said set of valid physical addresses.

4. The method as recited in claim 1, wherein said disabling a port bypass circuit associated with a selected device includes determining an enhanced logical address of said selected device.

5. The method as recited in claim 4, further comprising:
comparing said enhanced logical address of said selected device with said physical slot location of said selected device; and
reporting a fault condition in response to said enhanced logical address and said physical slot location of said selected device not being identical.

6. The method as recited in claim 4, further comprising:
comparing said enhanced logical address of said selected device with said physical slot location of said selected device;
responsive to said enhanced logical address and said physical slot location of said selected device not being identical, comparing said physical slot location of said selected device with said enhanced logical addresses of the remainder of said plurality of devices; and
reporting a fault condition in response to said physical slot location of said selected device not equal to one of said enhanced logical address of the remainder of said plurality of devices.

7. The method as recited in claim 1, wherein said disabling said port bypass circuits and performing a loop initialization includes determining an enhanced logical address for each of said plurality of devices.

8. The method as recited in claim 1, wherein said arbitrated loop is a fibre channel arbitrated loop (FC-AL).

9. The method as recited in claim 1, wherein said unique identifier is a world wide unique address (WWID) of said device.

10. The method as recited in claim 1, wherein said saving said unique identifier and said physical slot location of said selected device includes utilizing a first table.

11. The method as recited in claim 10, wherein said disabling said port bypass circuits and performing a loop initialization includes constructing a second table to store said unique identifiers.

12. The method as recited in claim 11, wherein said mapping said unique identifiers includes matching a unique identifier in said second table with an identical unique identifier in said first table to obtain a physical slot location.

13. A computer program product, comprising:
a computer-readable medium having stored thereon computer executable instructions for implementing a method for accurately determining a device location in an arbitrated loop having a plurality of devices and at least one initiator, wherein each of said plurality of devices having a port bypass circuit, said computer executable instructions when executed perform the steps of:
(a) enabling said port bypass circuits and initializing said arbitrated loop to determine said initiator's enhanced logical address;
(b) disabling a port bypass circuit associated with a selected device and determining a unique identifier and a physical slot location of said selected device;
(c) saving said unique identifier and said physical slot location of said selected device and enabling said port bypass circuit associated with said selected device;
(d) repeating (b) through (c) for each of said plurality of devices;
(e) disabling said port bypass circuits and performing a loop initialization of said arbitrated loop to determine a unique identifier for each of said plurality of devices; and
(f) mapping said unique identifiers determined in (e) with said unique identifiers associated with physical slot locations in (c) wherein said physical slot location of each of said plurality of devices is accurately determined.

14. The computer program product as recited in claim 13, further comprising determining a set of valid physical addresses for said plurality of devices.

15. The computer program product as recited in claim 14, further including assigning a preferred enhanced logical address to said initiator that does not correspond to an address in said set of valid physical addresses.

16. The computer program product as recited in claim 13, wherein said disabling a port bypass circuit associated with a selected device includes determining an enhanced logical address of said selected device.

17. The computer program product as recited in claim 16, further comprising:
comparing said enhanced logical address of said selected device with said physical slot location of said selected device; and
reporting a fault condition in response to said enhanced logical address and said physical slot location of said selected device not being identical.

18. The computer program product as recited in claim 16, further comprising:
comparing said enhanced logical address of said selected device with said physical slot location of said selected device;
responsive to said enhanced logical address and said physical slot location of said selected device not being identical, comparing said physical slot location of said selected device with said enhanced logical addresses of the remainder of said plurality of devices; and
reporting a fault condition in response to said physical slot location of said selected device not equal to one of said enhanced logical address of the remainder of said plurality of devices.

19. The computer program product as recited in claim 13, wherein said arbitrated loop is a fibre channel arbitrated loop (FC-AL).

20. The computer program product as recited in claim 13, wherein said unique identifier is a world wide unique address (WWID) of said device.

21. The computer program product as recited in claim 13, wherein said saving said unique identifier and said physical slot location of said selected device includes utilizing a first table.

22. The computer program product as recited in claim 21, wherein said disabling said port bypass circuits and performing a loop initialization includes constructing a second table to store said unique identifiers.

23. The computer program product as recited in claim 22, wherein said mapping said unique identifiers includes matching a unique identifier in said second table with an identical unique identifier in said first table to obtain a physical slot location.

24. An arbitrated loop network system, comprising:
a plurality of devices, including at least one initiator device, coupled to said arbitrated loop;
a hub, coupled to said plurality of device, having a plurality of port bypass circuits, each of said plurality of port bypass circuits associated with one of said plurality of devices;
(a) means for enabling said port bypass circuits and initializing said arbitrated loop to determine said initiator's enhanced logical address;
(b) means for disabling a port bypass circuit associated with a selected device and determining a unique identifier and a physical slot location of said selected device;
(c) means for saving said unique identifier and said physical slot location of said selected device and enabling said port bypass circuit associated with said selected device;
(d) means for repeating (b) through (c) for each of said plurality of devices;
(e) means for disabling said port bypass circuits and performing a loop initialization of said arbitrated loop to determine a unique identifier for each of said plurality of devices; and
(f) means for mapping said unique identifiers determined in (e) with said unique identifiers associated with physical slot locations in (c) wherein said physical slot location of each of said plurality of devices is accurately determined.

25. The system as recited in claim 24, further comprising means for determining a set of valid physical addresses for said plurality of devices.

26. The system as recited in claim 25, further including means for assigning a preferred enhanced logical address to said initiator that does not correspond to an address in said set of valid physical addresses.

27. The system as recited in claim 24, wherein said disabling a port bypass circuit associated with a selected device includes determining an enhanced logical address of said selected device.

28. The system as recited in claim 27, further comprising:
comparing said enhanced logical address of said selected device with said physical slot location of said selected device; and
reporting a fault condition in response to said enhanced logical address and said physical slot location of said selected device not being identical.

29. The system as recited in claim 27, further comprising:
comparing said enhanced logical address of said selected device with said physical slot location of said selected device;
responsive to said enhanced logical address and said physical slot location of said selected device not being identical, comparing said physical slot location of said selected device with said enhanced logical addresses of the remainder of said plurality of devices; and
reporting a fault condition in response to said physical slot location of said selected device not equal to one of said enhanced logical address of the remainder of said plurality of devices.

30. The system as recited in claim 24, wherein said arbitrated loop is a fibre channel arbitrated loop (FC-AL).

31. The system as recited in claim 24, wherein said unique identifier is a world wide unique address (WWID) of said device.

32. The system as recited in claim 24, wherein said means for saving said unique identifier and said physical slot location of said selected device includes means for utilizing a first table.

33. The system as recited in claim 32, wherein said means for disabling said port bypass circuits and performing a loop initialization includes means for constructing a second table to store said unique identifiers.

34. The system as recited in claim 33, wherein said means for mapping said unique identifiers includes means for matching a unique identifier in said second table with an identical unique identifier in said first table to obtain a physical slot location.
